(19) United States
(12) Patent Application Publication
(10) Pub. No.: US 2025/0182092 A1
(43) Pub. Date: Jun. 5, 2025

(54) A CONCEPT FOR RECOVERING ACCESS TO A CRYPTOCURRENCY WALLET ON A REMOTE SERVER

(71) Applicant: Sony Group Corporation, Tokyo (JP)

(72) Inventors: Hugo EMBRECHTS, Stuttgart (DE); Michele MINELLI, Stuttgart (DE); Guillaume BONNOT, Stuttgart (DE); Dimitri TORFS, Stuttgart (DE)

(73) Assignee: Sony Group Corporation, Tokyo (JP)

(21) Appl. No.: 18/845,885

(22) PCT Filed: Mar. 27, 2023
(86) PCT No.: PCT/EP2023/057804

§ 371 Date: Sep. 11, 2024

(30) Foreign Application Priority Data
Mar. 30, 2022 (EP) 22165294.4

(51) Int. Cl. G06Q 20/36; H04L 9/32

(52) U.S. Cl. CPC G06Q 20/3674; H04L 9/3265; H04L 2209/56

(57) ABSTRACT

This invention relates to a control apparatus, method, and program, as well as a service apparatus, method, and program. The control apparatus includes processing circuitry that registers a new cryptographic secret at a cryptocurrency wallet hosted in a trusted execution environment on a remote server. The process involves generating the cryptographic secret, authenticating the wallet owner through a wallet service application, and providing a control instruction for registering the secret at the wallet. Instructions for controlling the wallet are cryptographically protected using the newly registered cryptographic secret.

### FIELD

Examples relate to a concept for recovering access to a cryptocurrency wallet on a remote server, and in particular to a wallet control apparatus, wallet control method, and wallet control computer program, to a wallet service apparatus, wallet service method and wallet service computer program and service, which may be used to register a new cryptographic secret at a cryptocurrency wallet hosted in a trusted execution environment on a server.

### BACKGROUND

Cryptocurrencies, i.e., currencies that exist digitally and use cryptography to secure transactions, e.g., on a blockchain, are a field of research and development. Cryptocurrency transactions usually involve the use of a so-called wallet, which is a computer program being used to store and manage cryptographic secrets that can be used to sign cryptocurrency transactions.

There are different classes of cryptocurrency wallets. A first type of wallet is referred to as “self-custodial wallet”. In self-custodial wallets, the wallet owners do not rely on a third party to store and operate the private keys that control the assets in the wallet. There are different types of self-custodial wallets, such as hardware wallets, also called cold storage, web or mobile wallets, and desktop wallets. The recovery of lost, stolen, or broken devices is typically possible by using a recovery phrase (often 24 words) with which the keys can be regenerated. This recovery phrase must be stored in a safe place. Self-custodial wallets may be considered to carry a high risk for permanent loss because of human errors. A study shows that over 20% of all Bitcoin (a cryptocurrency) is lost permanently, e.g., due to loss of device or due to human error. This runs counter to the aim of making it easier for humans to engage in very complicated tasks without having to exert extreme mental effort or live in constant fear of making mistakes.

A second type of wallet is referred to as “custodial wallet”. When using a custodial wallet, the wallet owner delegates the storage and operation of private keys that control assets in a wallet to a third party. Typically, these third parties, such as big exchange markets, do not store the assets in individual wallets but keep them in large pools. In this respect, the wallet is more like an account on the bank. However, custodial wallets may be vulnerable to largescale attacks on custodial wallet providers. Moreover, the risk of bankruptcies of custodial wallet providers (sometimes because of large scale attacks) is non-negligible

A third type of wallet is referred to as “smart contract wallet”. The assets in a smart contract-based wallet are controlled by an (Ethereum) smart contract. Such smart contract wallets provide a number of different features, such as multi-signature authorization, rate limits, social recovery (friends can help recover the wallet), temporary locking of wallet, etc. However, smart contract wallets may be considered to be still rather sensitive to human errors (so that the wallet owners need to be well organized). The adaptation of concepts such as smart contracts is growing.

In Ethereum, transactions (ETH transfers, ERC20 transfers, smart contract calls) are issued with signatures signed by the private key corresponding to the public key associated with the account. In social recovery, 3-5 guardians can change which public key is associated with the account. In turn, the signing key can be used to sign a message that could change guardians after a delay (often 1-3 days).

There may be a desire for an improved concept for a cryptocurrency wallet, which reduces the risks for the wallet owners.

### SUMMARY

This desire is addressed by the subject-matter of the independent claims.

Various examples of the present disclosure are based on the finding, that a new type of wallet, called “guarded (crypto) wallet” along with a key recovery mechanism, can be used to provide a cryptocurrency wallet that reduces the risks for the wallet owners. In the proposed concept, the individual wallets of the wallet owners are managed and executed within a trusted execution environment on a remote server. Cryptographic secrets stored in the wallet and in a wallet control application (wallet control apparatus) being operated by the wallet owner create a link between the wallet and the wallet control application and allow the wallet owner to sign instructions for controlling the cryptocurrency wallet from their wallet control application. If the wallet control application is lost, e.g., as the computer or mobile device being used to execute the wallet control application fails or is lost, or as the application is removed in error, access can be restored by authenticating (e.g., using a government-backed identification scheme) vis-à-vis a wallet service application that is hosted within the trusted execution environment and installing a new (first) cryptographic secret at the wallet, which is subsequently used to verify instructions sent by the wallet control application. In addition, a second cryptographic secret can be installed, which allows the addition of further first cryptographic secret, or the replacement of a previously used for cryptographic secret. This results in a concept for a cryptographic wallet, where the owner remains in sole control of the cryptographic wallet, and where access to the wallet can be recovered in case it is temporarily lost due to loss or failure of a device or due to erroneous removal of the application. For example, the present disclosure may relate to a crypto-wallet with secure enclave covering also authentication with verifiable credentials.

Various aspects of the present disclosure relate to a wallet control apparatus. The wallet control apparatus comprises processing circuitry configured to register a new first cryptographic secret at a cryptocurrency wallet hosted in a trusted execution environment on a remote server. Registering the new first cryptographic secret comprises generating the first cryptographic secret. Registering the new first cryptographic secret comprises authenticating an owner of the cryptocurrency wallet vis-à-vis a wallet service application being executed in the trusted execution environment of the server. Registering the new first cryptographic secret comprises providing a control instruction for registering the first cryptographic secret at the cryptocurrency wallet to the wallet service application being executed in the trusted execution environment of the server based on the authentication. The processing circuitry is configured to provide instructions for controlling the cryptocurrency wallet to the remote server, with the instructions being cryptographically protected based on the first cryptographic secret. Through the authentication, the wallet service application ascertains that the rightful owner of the cryptocurrency wallet is attempting to regain access to the wallet, which is then regained by registering the new first cryptographic secret at the wallet. This enables recovery of access to the wallet when the previously used first cryptographic secret is lost.

For example, the processing circuitry may be configured to register the new first cryptographic secret after loss of a previously used first cryptographic secret. Thus, a new first cryptographic secret can be registered after loss of the previously used first cryptographic secret.

In some examples, the processing circuitry is configured to authenticate the owner of the cryptocurrency wallet using a signed identification certificate being signed by an independent entity. For example, the independent entity may provide, or be associated with, a trust anchor (e.g., a root Certificate Authority), which may vouch for the authenticity of the signed identification certificate. For example, the independent entity may be a government-run entity, where the owner obtain the signed identification after identifying themselves, in person, vis-à-vis the government-run entity.

For example, the processing circuitry may be configured to authenticate the owner of the cryptocurrency by signing the control instruction using a private key corresponding to the identification certificate. The signed control instruction may then be verified using the signed identification certificate.

For example, the processing circuitry may be configured to obtain the signed identification certificate from the independent entity. Thus, the signed identification certificate may be recovered from the independent entity upon loss of the signed identification certificate (e.g., if the previously used device has failed or is lost).

Authenticating vis-à-vis the wallet service application is not necessarily limited to the registration of a new first cryptographic secret. Other high-impact instructions, such as the definition or deletion of rate limits, may be secured via authentication as well, e.g., as a second factor. For example, the processing circuitry may be configured to authenticate the owner of the cryptocurrency wallet vis-à-vis the wallet service application being executed in the trusted execution environment of the server as secondary security measure for a subset of instructions for controlling the cryptocurrency wallet.

In cryptography, there are different approaches. In some examples, an approach called public key authentication is used, which is based on a key pair comprising a private key and a public key. The private key is generally held by the owner of the key, while the public key can be handed out and can be used to verify messages signed by the private key. For example, the first cryptographic secret may be a private key of a device authorization key pair. The processing circuitry may be configured to derive a public key of the device authorization key pair from the private key of the device authorization key pair. The processing circuitry may be configured to include the public key of the device authorization key pair in the control instruction for registering the first cryptographic secret. In other words, after generating the private key, a corresponding public key (for verifying instructions signed using the private key) may be transmitted to the wallet (service application) and stored there for verification of instructions provided by the wallet control apparatus.

The control instruction for registering the first cryptographic secret at the cryptocurrency wallet may comprise a first instruction for removing a previously used first cryptographic secret from the cryptocurrency wallet and a second instruction for registering the new first cryptographic secret at the cryptocurrency wallet. In other words, the previously used first cryptographic secret may be removed, which may increase the security in case the device comprising the previously used first cryptographic secret was lost.

In some examples, a further mechanism may be used for registering new devices (in addition to the authentication). For example, a device registration cryptographic secret (in the following called “second cryptographic secret”) may be used to register new devices (i.e., wallet control apparatuses). Upon loss of the wallet control apparatus (or of the mobile device comprising the wallet control apparatus), the second cryptographic secret may be renewed as well, i.e., in addition to the first cryptographic secret. For example, the processing circuitry may be further configured to register a new second cryptographic secret at the cryptocurrency wallet, by generating the second cryptographic secret, and providing a control instruction for registering the second cryptographic secret at the cryptocurrency wallet to the wallet service application being executed in the trusted execution environment of the server based on the authentication. As is evident, the new second cryptographic secret may be registered similarly to the new first cryptographic secret.

In some examples, the two new cryptographic secrets may be registered in the same instruction. For example, the processing circuitry may be configured to provide a joint control instruction for registering the first and second cryptographic secret at the wallet. Alternatively, separate instructions may be used. In other words, the processing circuitry may be configured to provide separate control instructions for registering the first and second cryptographic secret at the wallet.

As outlined above, the second cryptographic secret may be used to register new devices at the wallet. In other words, the second cryptographic secret may be a cryptographic secret for registering a new first cryptographic secret at the cryptocurrency wallet without requiring additional authentication of the owner of the cryptocurrency wallet vis-à-vis the wallet service application. For example, the second cryptographic secret may be a private key of a device registration key pair, with the processing circuitry being configured to derive a public key of the device registration key pair from the private key of the device registration key pair, and to include the public key of the device registration key pair in the control instruction for registering the second cryptographic secret. This way, a new (e.g., additional) device may be registered without requiring additional authentication vis-à-vis the wallet service application.

Various examples of the present disclosure relate to a corresponding wallet control method. The wallet control method comprises registering a new first cryptographic secret at a cryptocurrency wallet hosted in a trusted execution environment on a remote server. Registering the new first cryptographic secret comprises generating the first cryptographic secret. Registering the new first cryptographic secret comprises authenticating an owner of the cryptocurrency wallet vis-à-vis a wallet service application being executed in the trusted execution environment of the server. Registering the new first cryptographic secret comprises providing a control instruction for registering the first cryptographic secret at the cryptocurrency wallet to the wallet service application being executed in the trusted execution environment of the server based on the authentication. The wallet control method comprises providing instructions for controlling the cryptocurrency wallet to the remote server, the instructions being cryptographically protected based on the first cryptographic secret.

Various examples of the present disclosure relate to a corresponding computer program having a program code for performing the wallet control method, when the computer program is executed on a computer, a processor, or a programmable hardware component.

Various examples of the present disclosure relate to a mobile device comprising the wallet control apparatus introduced above.

Various examples of the present disclosure relate to a wallet service apparatus. For example, the wallet service apparatus may be part of the remote server. The wallet service apparatus comprises processing circuitry configured to provide a trusted execution environment. The processing circuitry is configured to host a cryptocurrency wallet inside the trusted execution environment. The processing circuitry is configured to host a wallet service application inside the trusted execution environment. The wallet service application is configured to authenticate an owner of the cryptocurrency wallet vis-à-vis the wallet service application. The wallet service application is configured to obtain a control instruction for registering a new first cryptographic secret at the cryptocurrency wallet from a wallet control apparatus. The wallet service application is configured to register the new first cryptographic secret at the cryptocurrency wallet. The wallet service application is configured to execute instructions for controlling the cryptocurrency wallet that are cryptographically protected based on the first cryptographic secret. Thus, upon authentication of the wallet control apparatus, for the owner of the cryptocurrency wallet, at the wallet service application, a new first cryptographic secret is installed.

As outlined in connection with the wallet control apparatus, the wallet service application may be configured to authenticate the owner of the cryptocurrency wallet based on a signed identification certificate being signed by an independent entity. This signed identification certificate may be used to verify a signature of the control instruction for registering the new first cryptographic secret, for example.

For example, the trusted execution environment may comprise a public key of a trust anchor associated with the independent entity and information on an identity of the owner of the cryptocurrency wallet. For example, the verification of the cryptographic signature may be based on a certificate chain, with the trust anchor being the root certificate of the certificate chain. The wallet service application may be configured to authenticate the owner of the cryptocurrency wallet by verifying a cryptographic signature using the public key of the trust anchor and by comparing the identification information included in the signed identification certificate with the identity of the owner of the cryptocurrency wallet. For example, the signed identification certificate may comprise a public key that can be used to verify the cryptographic secret, and identification information on the identity of the owner of the cryptocurrency wallet.

As outlined in connection with the wallet control apparatus, the control instruction for registering the first cryptographic secret at the cryptocurrency wallet may comprise a first instruction for removing a previously used first cryptographic secret from the cryptocurrency wallet and a second instruction for registering the new first cryptographic secret at the cryptocurrency wallet. The wallet service application may be configured to being configured to remove the previously used first cryptographic secret in addition to registering the new first cryptographic secret. In other words, the previously used first cryptographic secret may be removed, which may increase the security in case the device comprising the previously used first cryptographic secret was lost.

Some instructions may be protected using additional measures, e.g., using authentication vis-à-vis the wallet control application. For example, a subset of instructions for controlling the cryptocurrency wallet may require authenticating the owner of the cryptocurrency wallet as secondary security measure. The wallet service application may be configured to execute the subset of instructions upon authentication of the owner of the cryptocurrency wallet.

As outlined in connection with the wallet control apparatus, the first cryptographic secret may be a private key of a device authorization key pair. The control instruction for registering the first cryptographic secret may comprise the public key of the device authorization key pair. The wallet service application may be configured to store the public key of the device authorization key pair in the cryptocurrency wallet in the trusted execution environment. The public key of the device authorization key pair may subsequently be used to verify instructions received from the wallet control apparatus.

In addition to the first cryptographic secret, a second cryptographic secret may be installed, which may subsequently be used for registering neu devices. For example, the wallet service application may be configured to obtain a control instruction for registering a new second cryptographic secret at the cryptocurrency wallet from the wallet control apparatus. The wallet service application may be configured to register the second cryptographic secret at the cryptocurrency wallet, and to verify subsequent control instructions for registering a new first cryptographic secret based on the second cryptographic secret.

Similar to the first cryptographic secret, the second cryptographic secret may also be a private key, e.g., a private key of a device registration key pair. The control instruction for registering the second cryptographic secret may comprise the public key of the device registration key pair. The wallet service application may be configured to store the public key of the device registration key pair in the cryptocurrency wallet in the trusted execution environment. The public key of the device registration key pair may subsequently be used to verify subsequent control instructions for registering a new first cryptographic secret.

As outlined above, transactions on the cryptocurrency blockchain are signed using a cryptocurrency key (pair). This cryptocurrency key (pair) is generally stored inside the cryptocurrency wallet. The wallet service application may be configured to store a third cryptographic secret for signing transactions on a cryptocurrency blockchain in the cryptocurrency wallet in the trusted execution environment, and to sign the transactions on the cryptocurrency blockchain using the third cryptographic secret.

In general, software code running in the trusted execution environment, such as the wallet service application, may be audited by a third party. This may ensure that no data is exfiltrated by the remote server.

Various examples of the present disclosure relate to a corresponding wallet service method. The wallet service method comprises providing a trusted execution environment. The wallet service method comprises hosting a cryptocurrency wallet inside the trusted execution environment. The wallet service method comprises hosting a wallet service application inside the trusted execution environment. The wallet service application performs authenticating an owner of the cryptocurrency wallet vis-à-vis the wallet service application. The wallet service application performs obtaining a control instruction for registering a new first cryptographic secret at the cryptocurrency wallet from a wallet control apparatus. The wallet service application performs registering the new first cryptographic secret at the cryptocurrency wallet. The wallet service application performs executing instructions for controlling the cryptocurrency wallet that are cryptographically protected based on the first cryptographic secret.

Various examples of the present disclosure relate to a corresponding computer program having a program code for performing the wallet service method, when the computer program is executed on a computer, a processor, or a programmable hardware component.

Various examples of the present disclosure relate to a server comprising the wallet service apparatus introduced above.

Various examples of the present disclosure relate to system comprising the wallet control apparatus and the wallet service apparatus introduced above.

### BRIEF DESCRIPTION OF THE FIGURES

Some examples of apparatuses and/or methods will be described in the following by way of example only, and with reference to the accompanying figures, in which

FIG. 1a shows a block diagram of an example of a wallet control apparatus;

FIG. 1b shows a flow chart of an example of a wallet control method;

FIG. 2a shows a block diagram of an example of a wallet service apparatus and of a system comprising the wallet service apparatus and a wallet control apparatus;

FIG. 2b shows a flow chart of an example of a wallet service method;

FIG. 3 shows a schematic diagram of a system comprising a wallet control apparatus and a remote server hosting a cryptocurrency wallet;

FIG. 4 shows a schematic diagram of a remote server hosting a cryptocurrency wallet in a trusted execution environment;

FIG. 5 shows a schematic diagram of contents of a cryptocurrency wallet hosted by a remote server;

FIG. 6 shows a schematic diagram of a system comprising a wallet control apparatus and a remote server hosting a cryptocurrency wallet;

FIG. 7 illustrates how access to a cryptocurrency wallet hosted in a trusted execution environment of a remote server is transferred to other devices of a wallet owner;

FIG. 8 illustrates how rate limits and other usage controls can be set in a cryptocurrency wallet hosted in a trusted execution environment of a remote server;

FIG. 9 illustrates how a cryptocurrency wallet hosted in a trusted execution environment of a remote server can be protected via persistent storage and redundancy; and

FIG. 10 illustrates emergency measures that can be taken for recovering a cryptocurrency wallet hosted in a trusted execution environment of a remote server.

### DETAILED DESCRIPTION

Some examples are now described in more detail with reference to the enclosed figures. However, other possible examples are not limited to the features of these embodiments described in detail. Other examples may include modifications of the features as well as equivalents and alternatives to the features. Furthermore, the terminology used herein to describe certain examples should not be restrictive of further possible examples.

Throughout the description of the figures same or similar reference numerals refer to same or similar elements and/or features, which may be identical or implemented in a modified form while providing the same or a similar function. The thickness of lines, layers and/or areas in the figures may also be exaggerated for clarification.

When two elements A and B are combined using an “or”, this is to be understood as disclosing all possible combinations, i.e., only A, only B as well as A and B, unless expressly defined otherwise in the individual case. As an alternative wording for the same combinations, “at least one of A and B” or “A and/or B” may be used. This applies equivalently to combinations of more than two elements.

If a singular form, such as “a”, “an” and “the” is used and the use of only a single element is not defined as mandatory either explicitly or implicitly, further examples may also use several elements to implement the same function. If a function is described below as implemented using multiple elements, further examples may implement the same function using a single element or a single processing entity. It is further understood that the terms “include”, “including”, “comprise” and/or “comprising”, when used, describe the presence of the specified features, integers, steps, operations, processes, elements, components and/or a group thereof, but do not exclude the presence or addition of one or more other features, integers, steps, operations, processes, elements, components and/or a group thereof.

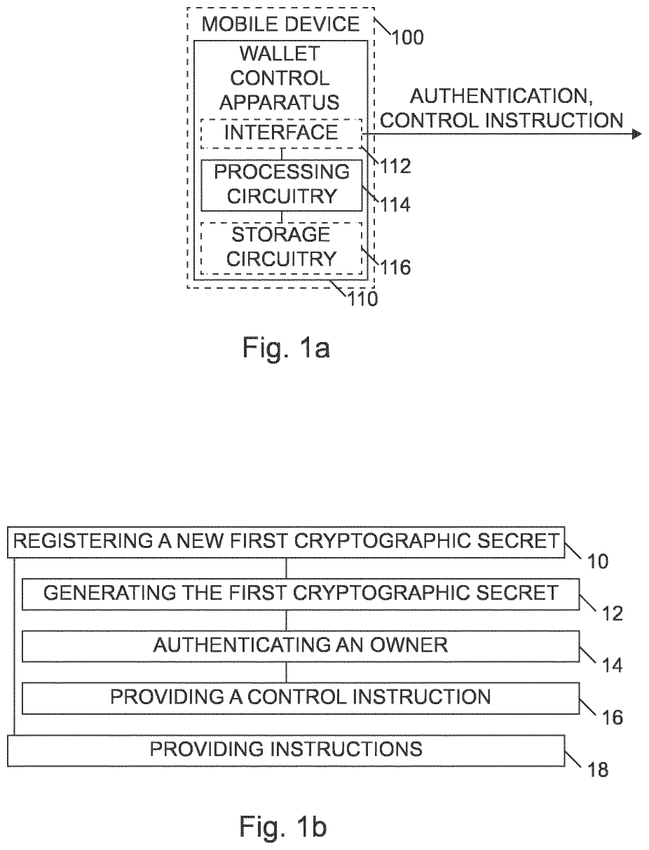

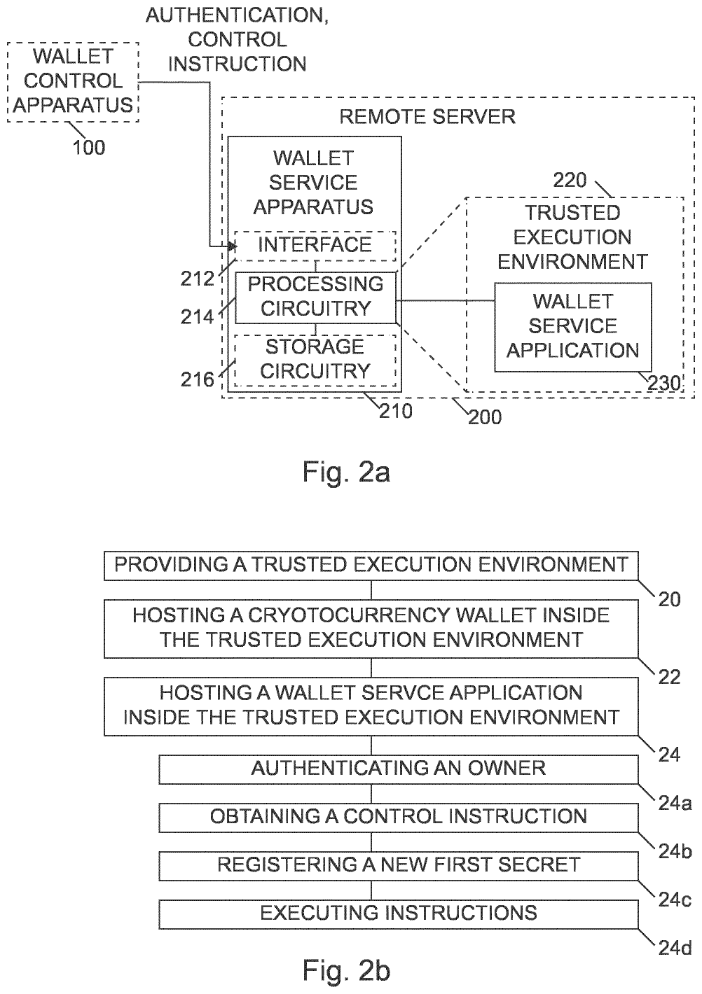

In FIGS. 1a to 2b, two components of the present disclosure are shown-a wallet control apparatus 110 (and corresponding wallet control method, wallet control computer program and mobile device 100 comprising the wallet control apparatus 110) and a wallet service apparatus 210 (and corresponding wallet service method, wallet service computer program and remote server 200 comprising the wallet service apparatus 210). As will become evident, these two components interact with each other. Accordingly, a major portion of the following introduction will focus on the interaction between the two components.

FIG. 1a shows a block diagram of an example of a wallet control apparatus 110. The wallet control apparatus 110 comprises processing circuitry 114, which is configured to provide the functionality of the wallet control apparatus 110. Optionally, the wallet control apparatus 110 further comprises an interface 112 (e.g., interface circuitry) for communicating with other entities, such as a remote server 200 (shown in FIG. 2a), and/or a storage circuitry 116 for storing information. The processing circuitry 114 shown in FIGS. 1a and 1c is coupled with the optional interface 112 and the optional storage circuitry 116. For example, the processing circuitry 114 may be configured to provide the functionality of the wallet control apparatus 110 in conjunction with the interface 112 (for communicating) and/or with the storage circuitry 116 (for storing and retrieving information). For example, the wallet control apparatus 110 may be part of a computer system, such as a personal computer, a tablet computer, or a smartphone. In particular, the wallet control apparatus may be part of a mobile device 100, such as a tablet computer or smartphone. The functionality of the wallet control apparatus may be provided as software, e.g., as a wallet control application being executed by the respective computer system.

The processing circuitry 114 is configured to register a new first cryptographic secret at a cryptocurrency wallet hosted in a trusted execution environment 220 on a remote server 200 (shown in FIG. 2a). Registering the new first cryptographic secret comprises generating the first cryptographic secret. Registering the new first cryptographic secret comprises authenticating an owner of the cryptocurrency wallet vis-à-vis a wallet service application being executed in the trusted execution environment of the server. Registering the new first cryptographic secret comprises providing a control instruction for registering the first cryptographic secret at the cryptocurrency wallet to the wallet service application being executed in the trusted execution environment of the server based on the authentication. The processing circuitry 114 is configured to provide instructions for controlling the cryptocurrency wallet to the remote server, the instructions being cryptographically protected based on the first cryptographic secret.

FIG. 1b shows a flow chart of an example of a corresponding wallet control method. The wallet control method comprises registering 10 the new first cryptographic secret at the cryptocurrency wallet hosted in the trusted execution environment on the remote server. Registering the new first cryptographic secret comprises generating 12 the first cryptographic secret. Registering the new first cryptographic secret comprises authenticating 14 an owner of the cryptocurrency wallet vis-à-vis a wallet service application being executed in the trusted execution environment of the server. Registering the new first cryptographic secret comprises providing 16 a control instruction for registering the first cryptographic secret at the cryptocurrency wallet to the wallet service application being executed in the trusted execution environment of the server based on the authentication. The wallet control method comprises providing 18 instructions for controlling the cryptocurrency wallet to the remote server, the instructions being cryptographically protected based on the first cryptographic secret.

FIG. 2a shows a block diagram of an example of a wallet service apparatus 210. The wallet service apparatus 210 comprises processing circuitry 214, which is configured to provide the functionality of the wallet service apparatus 210. Optionally, the wallet service apparatus 210 further comprises an interface 212 (e.g., interface circuitry) for communicating with other entities, such as the wallet control apparatus 110 or mobile device 100, and/or a storage circuitry 216 for storing information. The processing circuitry 214 shown in FIGS. 1a and 1c is coupled with the optional interface 212 and the optional storage circuitry 216. For example, the processing circuitry 214 may be configured to provide the functionality of the wallet service apparatus 210 in conjunction with the interface 212 (for communicating) and/or with the storage circuitry 216 (for storing and retrieving information). For example, the wallet service apparatus 210 may be part of a computer system, such as a server. The functionality of the wallet service apparatus may be provided or controlled via software, e.g., by a wallet service application and/or an application for controlling a trusted execution environment.

The processing circuitry 214 is configured to provide the trusted execution environment 220. The processing circuitry 214 is configured to host a cryptocurrency wallet inside the trusted execution environment. The processing circuitry 214 is configured to host a wallet service application 230 inside the trusted execution environment. The wallet service application 230 is configured to authenticate an owner of the cryptocurrency wallet vis-à-vis the wallet service application. The wallet service application 230 is configured to obtain a control instruction for registering a new first cryptographic secret at the cryptocurrency wallet from a wallet control apparatus. The wallet service application 230 is configured to register the new first cryptographic secret at the cryptocurrency wallet. The wallet service application 230 is configured to execute instructions for controlling the cryptocurrency wallet that are cryptographically protected based on the first cryptographic secret.

FIG. 2a further shows a server 200 comprising the wallet service apparatus 210. FIG. 2a further shows a system comprising the wallet service apparatus 210 and the wallet control apparatus 110, e.g., the server 200 comprising the wallet service apparatus 210 and the mobile device 100 comprising the wallet control apparatus 110.

FIG. 2b shows a flow chart of an example of a corresponding wallet service method. The wallet service method comprises providing 20 the trusted execution environment. The wallet service method comprises hosting 22 the cryptocurrency wallet inside the trusted execution environment. The wallet service method comprises hosting 24 the wallet service application inside the trusted execution environment. The wallet service application performs the acts of authenticating 24a an owner of the cryptocurrency wallet vis-à-vis the wallet service application, obtaining 24b a control instruction for registering a new first cryptographic secret at the cryptocurrency wallet from a wallet control apparatus, registering 24c the new first cryptographic secret at the cryptocurrency wallet, and executing 24d instructions for controlling the cryptocurrency wallet that are cryptographically protected based on the first cryptographic secret.

The features of the wallet control apparatus, wallet control method, wallet control computer program and mobile device on the one hand, and of the wallet service apparatus, wallet service method, wallet service computer program and server will now be introduced in more detail with respect to the wallet control apparatus and wallet service apparatus. Features introduced in connection with the wallet control apparatus and wallet service apparatus may likewise be included in the wallet control method, wallet control computer program and mobile device, and wallet service method, wallet service computer program and server, respectively.

The proposed concept is directed at registering a new first cryptographic secret at a cryptocurrency wallet hosted in a trusted execution environment on the remote server 200. Such a scenario may occur after initialization of the cryptocurrency wallet. For example, during initialization of the cryptocurrency wallet, the respective cryptographic secrets may be generated by the wallet control apparatus and be transmitted to the remote server to be stored in the cryptocurrency wallet. After the cryptocurrency wallet is initialized, if the respective cryptographic are lost, e.g., due to loss or failure of device or due to incorrect operation of the wallet control apparatus or device, the proposed concept may be used to store a new first cryptographic secret in the wallet, e.g., replacing a previously used first cryptographic secret. For example, the processing circuitry of the wallet control apparatus may be configured to register the new first cryptographic secret after loss of a previously used first cryptographic secret.

In the proposed concept, the cryptocurrency wallet is stored in a trusted execution environment of the server. Accordingly, the wallet service apparatus is configured to provide, e.g., make available, control, or make accessible such a trusted execution environment. There are various implementations of trusted execution environments. A trusted execution environments may also be called a secure enclave, for example. In general, a trusted execution environment is an execution environment that is encapsulated from (i.e., shielded from) other processes being executed on the processing circuitry providing the trusted execution environment. In particular, processes being executed outside the particular trusted execution environment may be unable to read out, or write into, data or code being contained in the trusted execution environment. In the proposed concept, in particular, the contents of the wallet, and the wallet service application, might not be accessible from outside the trusted execution environment, e.g., except for an interface being used to update the wallet service application. For example, the software code of the wallet service application being executed in the trusted execution environment may be audited by a third party. It may be updated using the above-referenced interface, which may be cryptographically protected. The contents of the wallet may remain shielded inside the trusted execution environment at any point.

In various examples of the present disclosure, public-private-key cryptography is used. In other words, a private key of a cryptographic key pair is used to sign something, e.g., an instruction, or a certificate of identity, and the corresponding public key can be used to verify the signature. On the other hand, the public key of the cryptographic key pair can be used to encrypt a piece of information, while the private key can be used to decrypt the piece of formation.

For example, the first cryptographic secret (and also a second cryptographic secret that will be introduced in the following) may be a key of a cryptographic key pair. For example, the first cryptographic secret may be a private key of a device authorization key pair. In general, the device authorization key pair may be used for signing and verifying control instructions being issued by the wallet control apparatus for the wallet. The private key may reside with the wallet control apparatus and may be used to sign the control instructions, while the public key may be stored in the cryptocurrency wallet. Accordingly, the processing circuitry of the wallet control apparatus may be configured to generate the device authorization key pair with the private key and the public key. For example, the processing circuitry of the wallet control apparatus may be configured to derive a public key of the device authorization key pair from the private key of the device authorization key pair. The processing circuitry of the wallet control apparatus may be configured to transmit the public key to the wallet service application for storage in the cryptocurrency wallet. For example, the processing circuitry of the wallet control apparatus may be configured to include the public key of the device authorization key pair in the control instruction for registering the first cryptographic secret. In other words, the control instruction for registering the first cryptographic secret may comprise the public key of the device authorization key pair.

In the proposed concept, the new first cryptographic secret is registered at the cryptocurrency wallet upon authentication of the wallet control apparatus, and thus owner of the cryptocurrency wallet, vis-à-vis the wallet service application, which is executed inside the trusted execution environment. This authentication may be secured by the fact that the entity performing the authentication, i.e., the wallet service application, is executed inside the trusted execution environment, so that a manipulation of the software code being used to handle the authentication on the server side is protected inside the trusted execution environment.

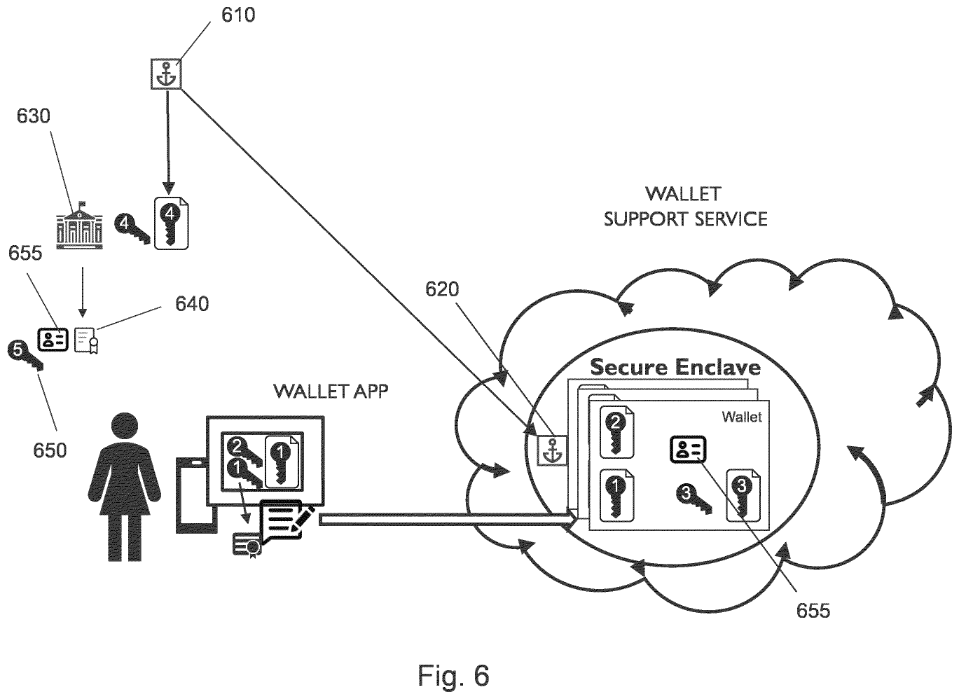

Many variations are now possible for the authentication scheme (used for wallet recovery). For example, the processing circuitry of the wallet control apparatus may be configured to authenticate the owner of the cryptocurrency wallet vis-à-vis the wallet service application by providing a signed identification certificate (e.g., a government agency-signed ID certificate 640 as shown in FIG. 6) to the remote server. Accordingly, the wallet service application may be configured to authenticate the owner of the cryptocurrency wallet based on the signed identification certificate. For example, the signed identification certificate may be signed by an independent entity (e.g., an entity that is associated with a trust anchor, i.e., that is capable of signing identification certificates that can be verified against a trust anchor), such as a government agency. For example, as shown in FIG. 6, the signed identification certificate may be provided by signing an instruction (e.g., the control instruction for registering the new first cryptographic secret or an authentication instruction) with a private key 650 linked with the identification certificate 640 (and providing the signed identification certificate with the signed instruction). On the side of the wallet service application, the trusted execution environment may comprise a public key of a trust anchor associated with the independent entity and information on an identity of the owner of the cryptocurrency wallet. The wallet service application may be configured to authenticate the owner of the cryptocurrency wallet by verifying a cryptographic signature (that the control instruction or a previous authentication instruction is based on) using the public key of the trust anchor and by comparing the identification information included in the signed identification certificate with the identity of the owner of the cryptocurrency wallet. The wallet control apparatus may receive the signed identification certificate from the independent entity. For example, the processing circuitry of the wallet control apparatus may be configured to obtain the signed identification certificate from the independent entity.

For example, the authentication that is based on the signed identification certificate may be similar to authentication performed according to Transport Layer Security (TLS). TLS a cryptographic protocol that is used to provide communication security for communications that occur over a computer network, e.g., between a web server and a web browser. In TLS, the server provides an identification certificate to the client, comprising the name of the server, a reference to the trusted certificate authority (CA) that vouches for the authenticity of the certificate, and the public key of the server. The client uses the public key of the server to encrypt a first encrypted message comprising a random number, which the server can decrypt using its private key. The random number can now be used for encryption of a Diffie-Hellman key exchange, which results in a session key that is used for the subsequent communication. As mentioned above, the identification certificate provided by the server comprises a reference to the trusted CA that vouches for the authenticity of the certificate. Thus, a certificate chain is formed from the identification certificate to the trusted CA. In many cases, the CA being referenced is not a root CA, but an intermediate CA. Therefore, to verify the authenticity of the certificate, the client follows the certificate chain to the intermediate CA, which also provides a similar identification certificate, which may include a reference to a further intermediate CA or to the root CA. Thus, the certificate chain is extended to the further intermediate CA or to the root CA. Once the certificate chain arrives at the root CA, the certificate chain is complete. The CAs are typically organized in a hierarchical tree structure, which all link back to the root CA at the top of the tree. The public key associated with the signing key of the root CA is called the trust anchor. The trust anchor is typically hard coded in entities that need to authenticate another party, which is why it is called a trust anchor. For example, the public key of the root CA may be stored in a “trusted root CAs” store of the client and serve as the trust anchor of the verification procedure. The client may traverse the certificate chain to the root CA verify the authenticity of the identification certificate.

In the proposed concept, a similar scheme may be used, wherein the wallet control apparatus takes the role of the server (of the TLS scheme), and the remote server takes the role of the client (of the TLS scheme). For example, the wallet control apparatus may generate or obtain a private key of the owner of the wallet, which is then registered with the government agency associated with the trust anchor being used. The government agency may sign the private key registered at the government agency and generate the identification certificate thereupon (with the public key of the owner and an identifier, e.g., passport number, identifying the owner, and a reference to the trust anchor). The wallet control apparatus may sign the control instruction for registering the new first cryptographic secret using the private key. The remote server may now use the signed identification certificate, which is vouched for by the trust anchor, to verify that instructions issued by the wallet control apparatus are issued by the owner of the identification certificate. SSI is a more modern adaptation of this scheme, which makes use of blockchain technology.

For example, the remote server may automatically verify the signed identification certificate. For example, the wallet service application may be configured to obtain the signed identification certificate from the wallet control apparatus. As outlined above, the signature of the signed identification certificate may be derived from the trust anchor. In this case, the wallet service application may be configured to verify the signed identification certificate based on a public key of the trust anchor (and based on the stored credentials 655 of the wallet owner, as shown in FIG. 6). The wallet service application may be configured to authenticate the owner vis-à-vis the wallet service application based on the signed identification certificate of the owner and based on information on an identity of the owner of the cryptocurrency wallet (e.g., the credentials/ID number of the wallet owner 655) stored in the cryptocurrency wallet. As outlined above, the verification of the cryptographic signature is based on a certificate chain, with the trust anchor being the root certificate of the certificate chain.

To register the new first cryptographic secret at the cryptocurrency wallet, a control instruction is generated, optionally signed, and transmitted. In contrast to other instructions for controlling the wallet, this control instruction is not signed using the first cryptographic secret (e.g., the private key of the device authorization key pair) as the previously used first cryptographic secret (which is known to the cryptocurrency wallet) is lost. For example, the control instruction may remain unsigned, or it may be signed using a private key associated with an identification certificate of the owner of the cryptocurrency wallet (e.g., for authentication). For example, the control instruction may instruct the cryptocurrency wallet to register the new first cryptographic secret (and in particular the public key of the new device authorization key pair) at the wallet. In addition, the control instruction may instruct the cryptocurrency wallet to remove the previously used first cryptographic secret (i.e., the public key of the previously used device authorization key pair) from the cryptocurrency wallet. In other words, the control instruction for registering the first cryptographic secret at the cryptocurrency wallet may comprise a first instruction for removing a previously used first cryptographic secret from the cryptocurrency wallet and a second instruction for registering the new first cryptographic secret at the cryptocurrency wallet. Once the control instruction is generated, and optionally signed, it is transmitted to the remote server. In this context, the term signing means that a cryptographic key is used to generate a digital signature that is based on the control instruction (e.g., based on a hash value of the control instruction, including the public key of the device authorization key pair), and that can be used to verify that a) the control instruction has not been tampered with, and b) that the control instruction has been signed by an entity that is associated with the owner of the cryptocurrency wallet (and thus authorized to issue the control instruction).

At the remote server, and in particular at the cryptocurrency wallet inside the trusted execution environment, the control instruction may be verified (if signed), and the public key of the device authorization key pair may be extracted from the control instruction and stored in the cryptocurrency wallet. For example, the wallet service application may be configured to verify the signed control instruction for registering the first cryptographic secret based on the signed identification certificate being used for authentication. The wallet service application may be configured to extract the public key of the device authorization key pair from the control instruction. For example, the wallet service application may be configured to store the public key of the device authorization key pair in the cryptocurrency wallet in the trusted execution environment. For example, in some cases, e.g., if the control instruction for registering the first cryptographic secret at the cryptocurrency wallet comprises an instruction for removing a previously used first cryptographic secret, the wallet service application may be configured to remove the previously used first cryptographic secret in addition to registering the new first cryptographic secret.

If the registration of the new first cryptographic secret is successful, the remote server may acknowledge the successful registration of the wallet control apparatus. For example, the processing circuitry of the wallet control apparatus may be configured to obtain a response from the remote server in response to the control instruction for registering the first cryptographic secret at the cryptocurrency wallet. For example, the response may comprise a confirmation of the cryptocurrency wallet if the private key of the device registration key pair matches the public key of the device registration key pair stored in the cryptocurrency wallet, i.e., if the control instruction that is signed by the private key of the device registration key pair could be verified using the public key of the device registration key pair stored inside the cryptocurrency wallet. Accordingly, the wallet service application may be configured to provide the response to the wallet control apparatus upon successful registration of the new first cryptographic secret.

Once the new first cryptographic secret is installed at the wallet, it can be used to sign subsequent instructions for controlling the cryptocurrency wallet. The processing circuitry of the wallet control apparatus is configured to provide (subsequent) instructions for controlling the cryptocurrency wallet to the first remote server, with the instructions being cryptographically protected based on the first cryptographic secret. For example, the instructions may be cryptographically signed using the new first cryptographic secret, e.g., the private key of the device authorization key pair).

In some examples, a second cryptographic secret may be registered at the cryptocurrency wallet as well. This second cryptographic secret is a cryptographic secret for registering a new first cryptographic secret at the cryptocurrency wallet without requiring additional authentication of the owner of the cryptocurrency wallet vis-à-vis the wallet service application. For example, once it is registered at the cryptocurrency wallet, additional (or replacement) first cryptographic secrets may be registered at the cryptocurrency wallet by signing the control instruction for registering the respective first cryptographic secret with the second cryptographic secret.

To register the second cryptographic secret at the wallet, the processing circuitry may be configured to generate the second cryptographic secret and provide a control instruction for registering the second cryptographic secret at the cryptocurrency wallet to the wallet service application being executed in the trusted execution environment of the server based on the authentication. For example, the processing circuitry may be configured to provide a joint control instruction for registering the first and second cryptographic secret at the wallet, or to provide separate control instructions for registering the first and second cryptographic secret at the wallet. At the remote server, the wallet service application may be configured to obtain the control instruction for registering a new second cryptographic secret at the cryptocurrency wallet from the wallet control apparatus, to register the second cryptographic secret at the cryptocurrency wallet, and to verify subsequent control instructions for registering a new first cryptographic secret based on the second cryptographic secret. As is evident, the procedure for registering a new second cryptographic secret may be implemented similarly to the registration of the new first cryptographic secret.

Similar to the first cryptographic secret, the second cryptographic secret may be part of a cryptographic key pair as well. For example, the second cryptographic secret may be a private key of a device registration key pair. For example, the device registration key pair may be used for registering new device that are authorized to control the cryptocurrency wallet. The original device registration key pair may be generated during initialization of the wallet, with the private key (i.e., the second cryptographic secret) being stored in the wallet control apparatus. To register a new second cryptographic secret, a new private key of the device registration key pair may be generated (i.e., the second cryptographic secret), and a new public key may be derived from the new private key of the device registration key pair. The public key of the device registration key pair may be stored at the cryptocurrency wallet, so that it can be used by the server (e.g., the cryptocurrency wallet) to verify subsequent control instructions for registering a first cryptographic secret. For example, the public key of the device registration key pair may be included in the control instruction for registering the new second cryptographic secret. Accordingly, the control instruction for registering the second cryptographic secret may comprise the public key of the device registration key pair. The wallet service application may be configured to store the public key of the device registration key pair in the cryptocurrency wallet in the trusted execution environment.

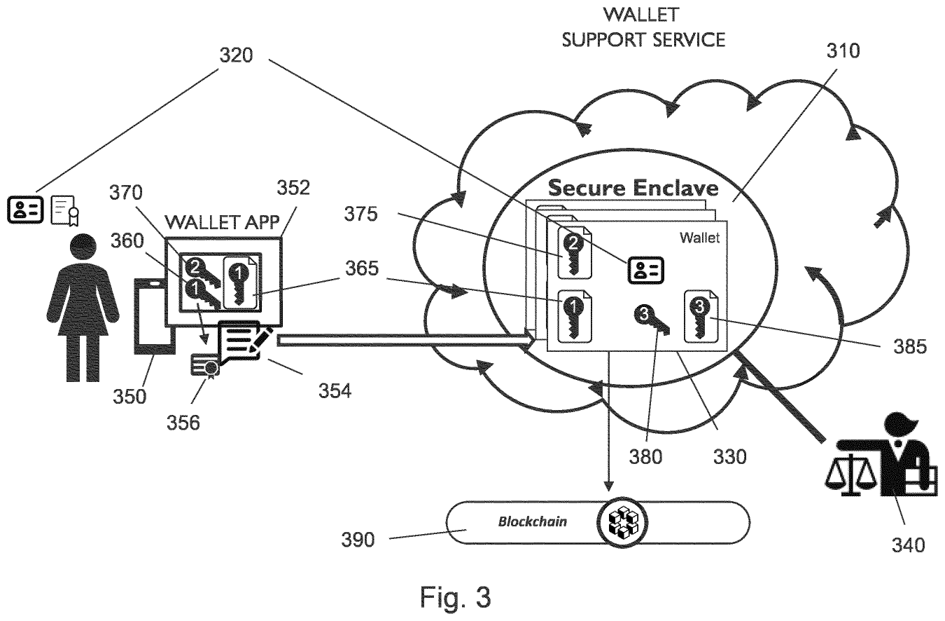

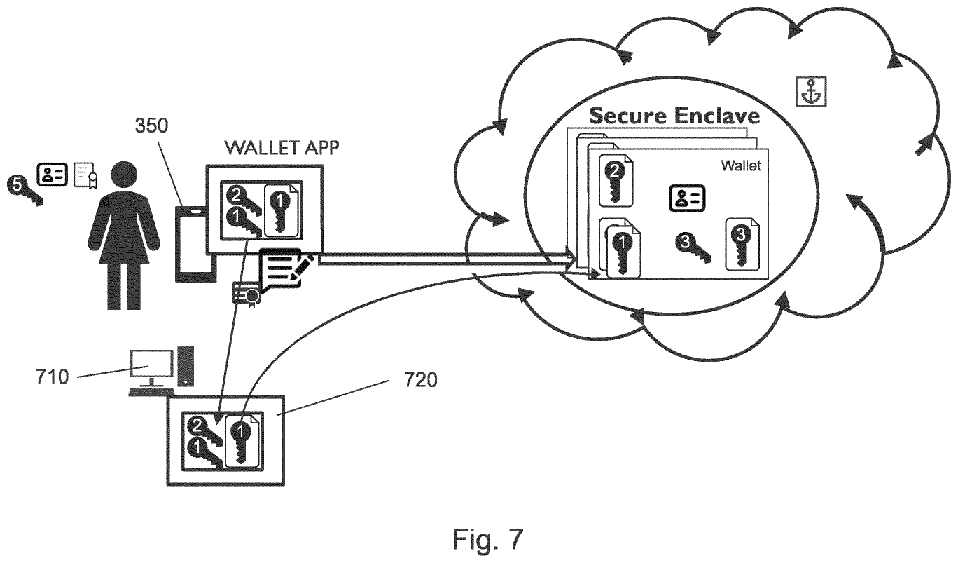

A more detailed introduction of the (optional) features and functionality of the wallet control apparatus, wallet control method, wallet control computer program, wallet service apparatus, wallet service method, wallet service computer program and system will subsequently be given in connection with FIGS. 3 to 10. In FIGS. 3 to 10, the wallet control apparatus is denoted “Wallet App” 352 (in FIG. 2, 7) or “Crypto Wallet”. It may be comprised in a mobile device 350 (shown in FIGS. 2 and 7) or a personal computer 710 (shown in FIG. 7). The remote server is denoted “Wallet Support Service”.

The interface 112; 212 of the wallet control apparatus 110 and/or the wallet service apparatus 210 may correspond to one or more inputs and/or outputs for receiving and/or transmitting information, which may be in digital (bit) values according to a specified code, within a module, between modules or between modules of different entities. For example, the interface 112; 212 of the wallet control apparatus 110 and/or the wallet service apparatus 210 may comprise interface circuitry configured to receive and/or transmit information.

For example, the processing circuitry 114; 214 of the wallet control apparatus 110 and/or the wallet service apparatus 210 may be implemented using one or more processing units, one or more processing devices, any means for processing, such as a processor, a computer or a programmable hardware component being operable with accordingly adapted software. In other words, the described function of the 114; 214 of the wallet control apparatus 110 and/or the wallet service apparatus 210 may as well be implemented in software, which is then executed on one or more programmable hardware components. Such hardware components may comprise a general-purpose processor, a Digital Signal Processor (DSP), a micro-controller, etc. For example, at least the processing circuitry 214 of the wallet service apparatus 210 may be suitable for, e.g., configured to, providing/provide a trusted execution environment, such as Intel Software Guard Extensions, AMD Platform Security Processor or Secure Encrypted Virtualization, ARM TrustZone or RISC-V MultiZone.

For example, the storage circuitry 116; 216 of the wallet control apparatus 110 and/or the wallet service apparatus 210 may comprise at least one element of the group of a computer readable storage medium, such as an magnetic or optical storage medium, e.g. a hard disk drive, a flash memory, Floppy-Disk, Random Access Memory (RAM), Programmable Read Only Memory (PROM), Erasable Programmable Read Only Memory (EPROM), an Electronically Erasable Programmable Read Only Memory (EEPROM), or a network storage.

More details and aspects of the wallet control apparatus, wallet service apparatus, remote server, wallet control method, wallet service method, system and computer program are mentioned in connection with the proposed concept, or one or more examples described above or below (e.g., FIGS. 3 to 10). The wallet control apparatus, wallet service apparatus, remote server, wallet control method, wallet service method, system and computer program may comprise one or more additional optional features corresponding to one or more aspects of the proposed concept, or one or more examples described above or below.

In FIGS. 1a to 2b, a core functionality of a concept denoted “guarded (crypto) wallet” has been introduced. This wallet is a new wallet type, which may be suitable for the average, non-tech-savvy user who is not well organized. For example, it may be setup as a (paid) service that releases the user from worries about loss of keys. It may provide an easy, unsophisticated user experience, e.g., with a minimal user configuration for recovery. If possible, it may be implemented as a self-custodial wallet, while carrying a reduced security risk for (large scale) attacks.

The proposed concept comprises three components—the remote server, which may be a cloud service that stores the wallet assets (private keys) using secure enclave technology (like Intel SGX) in such a way that the cloud provider cannot access the wallet assets. This makes the proposed concept self-custodial. The wallet may be operated by the users from a wallet control apparatus (the second component), which may be hosted by a mobile phone, from which signed wallet instructions are sent to the wallets in the cloud where the wallet instructions are executed.

Optionally, an external authentication infrastructure outside the control of the cloud service may be used for wallet access and/or recovery. For example, an SSI (Self-Sovereign Identity) infrastructure may be used. For example, SSI keys may be used that the user has registered with a government authority and for which the user received verifiable credentials. Alternatively, other forms of authentication infrastructure may be used for access to government websites, banking services, etc. To verify the verifiable certificates used for authentication, the cloud service may configure trust anchors, ideally inside the enclave. These may be updated through software updates.

FIG. 3 shows a schematic diagram of a system comprising a wallet control apparatus (Wallet App 352) and a remote server hosting a cryptocurrency wallet 330. FIG. 3 shows the wallet support service with the secure enclave(s) 310 (the trusted execution environment). The secure enclave shields the cloud owner from the operations in the enclave (so that a self-custodial cryptocurrency wallet can be implemented). The enclave (or enclaves) may isolate small kernels of security sensitive code (such as the wallet service application) from the operating system and main software stacks. It may provide strong protection against attacks. Inside the secure enclave, individual user wallets 330 store the asset keys.

For reclaiming access to a wallet 330, the proposed concept may use a form of authentication that is renewable. For example, SSI certificates 320 handed out by government may be used for authentication. These certificates 320 can be held by the owner and stored in the wallet 330 inside the secure enclave 310. In this context, “renewable” means that the wallet owner can lose an authentication secret (e.g., a private key linked to an authentication certificate issued by a SSI run by a government agency), generate a new authentication secret, register it with the government agency, which will provide a new SSI certificate (signed identification certificate), signed by the government agency.

A challenge with the secure enclave is that the code may have to be upgraded regularly for new functionality and security and other (hot) fixes. For this, a mechanism may be used that forces the cloud provider to involve an independent auditing party 340 for any change applied to the code. The independent auditing party 340 may verify the sanity of the code running in the enclave and control the upgrading process of the code. In other words, software code running in the trusted execution environment may be audited by a third party. While this breaks the self-custodial character of the proposed concept somewhat, it should yield guarantees that wallet keys cannot be accessed by anybody involved in daily operations of the cloud service.

FIG. 3 shows a mobile device 350 of the owner with wallet app 352 (the wallet control apparatus). The wallet app 352 contains two private keys-private key 360 and public key 365 of a device authorization key pair and a private key 370 of a device registration key pair. The wallet app 352 uses the private key 360 of the device authorization kay pair to add a signature 356 to an instruction 354 for performing a wallet operations. The wallet 330 comprises the public keys 365; 375 of the device authorization and device registration key pairs. The wallet 330 further comprises a private key 380 and a public key 385 of a wallet (blockchain) key pair for performing operations on the blockchain 390. In other words, the wallet service application may be configured to store a third cryptographic secret (e.g., the wallet key pair, the private key of the wallet key pair, or a seed key of a hierarchical deterministic (HD) scheme used for generating the private keys for signing transactions on the blockchain) for signing transactions on a cryptocurrency blockchain 390 in the cryptocurrency wallet in the trusted execution environment. For example, the wallet service application may be configured to sign the transactions on the cryptocurrency blockchain using the third cryptographic secret.

In general, the private key of the respective public/private key pairs may be used to sign messages, data structures etc. The public key of the respective public/private key pairs may be used when verifying whether a signature is created with the corresponding private key. To send crypto assets, the private key of the wallet key pair may be used for signing transactions on the cryptocurrency blockchain, with the private key of the wallet key pair being cryptographic code that functions as a secret password that allows the user to sign a cryptocurrency transaction and transfer funds to another cryptocurrency address.

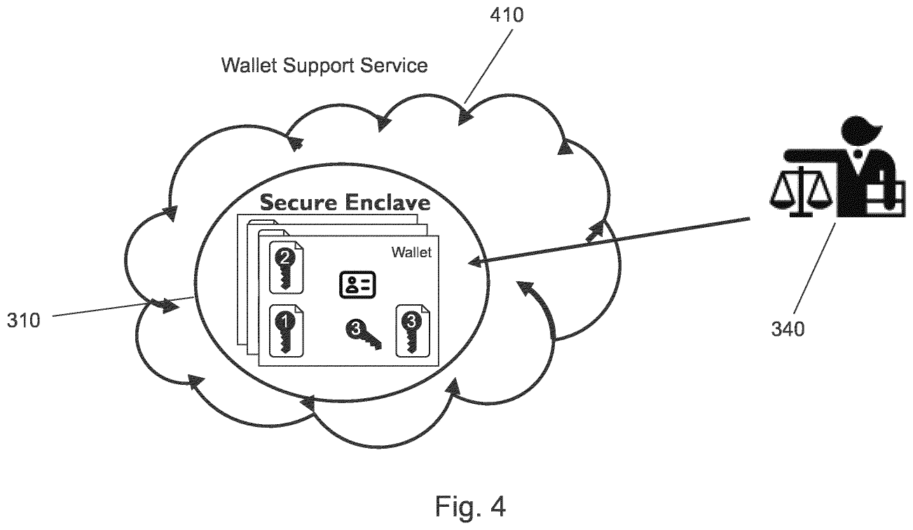

In FIG. 4, the properties of the trusted execution environment (secure enclave) and content of the cryptocurrency wallet according to an example are shown in more detail. FIG. 4 shows a schematic diagram of a remote server hosting a cryptocurrency wallet in a trusted execution environment (secure enclave) 410.

FIG. 4 shows the secure enclave 310 with the cryptocurrency wallet. In various examples, the wallet service operators cannot access the wallet keys (stored inside the secure enclave), cannot initiate any operation with a wallet key. Code running in the secure enclave is highly protected code, e.g., small kernels of code with only critical pieces of functionality. This may mitigate security risks caused by large software stacks with zero-day vulnerabilities.

The wallet support service 410 (provided by the remote server) may be linked to natural persons with “bank level security” and renewable authentication (such as eID (electronic identification), bank card token, etc.).

The independent auditor 340 may review the code running in the enclave and confirm proper behavior and security. When a software update is due, the running code may hand over internal keys to the new version of the code, if that latter is signed by the auditing service. In addition, the independent auditor 340 may approve changes (in software updates) of trust anchors for identify certificate validation.

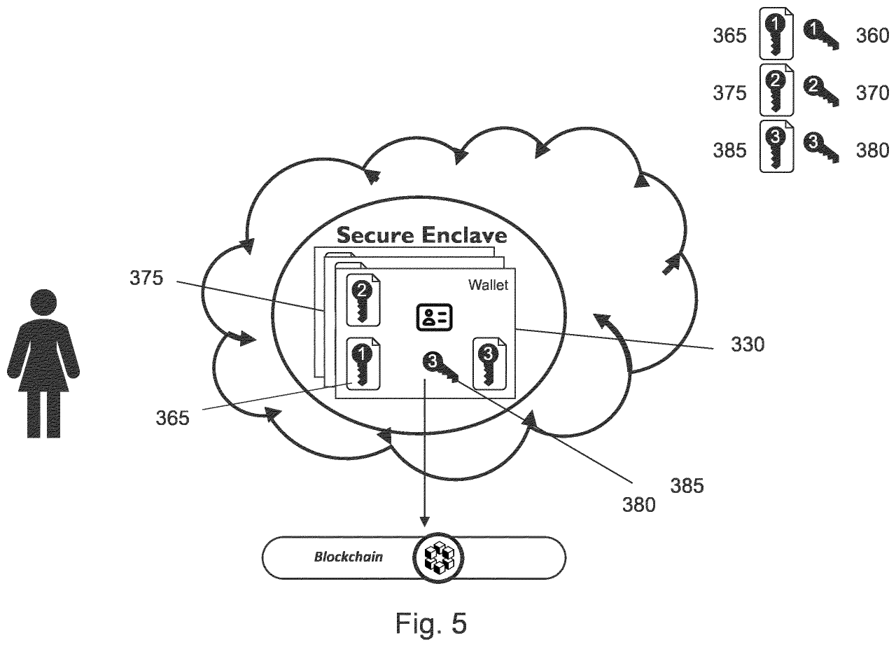

FIG. 5 shows a schematic diagram of contents of an example of a cryptocurrency wallet hosted by the remote server. The proposed concept may aim to create a self-custodial wallet that is hosted by a wallet support service. Therefore, each wallet may be associated with a single user (a wallet per use). The cryptocurrency wallet may comprise the device authorization public key 365. A party that holds the corresponding private key 360 can issue operations on the assets in this wallet. The cryptocurrency wallet may comprise the device registration public key 375. A party that holds the corresponding private key 370 can register/unregister devices that can control this wallet. The cryptocurrency wallet may comprise the wallet key pair 380; 385 generated by the wallet service at user wallet creation time. The private key of the wallet key pair controls the assets associated with the wallet (by signing blockchain operations).

FIG. 6 shows a schematic diagram of a system comprising the wallet control apparatus and the remote server hosting the cryptocurrency wallet. FIG. 6 illustrates components that may be used to perform authentication inside the secure enclave, e.g., vis-à-vis the wallet support application. In FIG. 6, a trust anchor 610 (with respect to certificate chains) is introduced, which may be the anchor of trust with respect to the authentication of the wallet owner vis-à-vis the remote server. For example, the trust anchor may be the root certificate that is used across government agencies. In particular, it may be used for wallet recovery. For example, the remote server may use the trust anchor to verify the identity (e.g., a signed identification certificate) of the owner of the cryptocurrency wallet. For example, the wallet service application may be configured to store a public key 620 of the trust anchor in the secure enclave and to store information on an identity 655 of the owner of the cryptocurrency wallet in the wallet in the trusted execution environment.

In FIG. 6, the trust anchor 610 is used by a government ID (identification) issuing agency 630 (which may support SSI), which may provide an ID certificate (identification certificate) 640 (with a user public key), with the ID certificate being signed by the agency, and a private key 650 that signs authentication requests. The wallet owner's national ID number 655 is stored in the wallet (at wallet creation time). Authentication requests signed by the wallet owner and accompanied with the ID certificate (or SSI proof of it) can be verified against the trust anchor(s).

In the following, the creation of the cryptocurrency wallet in the cloud is discussed. As shown in FIG. 3, the crypto wallet (wallet control apparatus) of the user on their mobile device comprises the device registration private key 370 and device authorization private key 360 that may be generated in the Crypto Wallet/App of user. The device registration public key 375 and device authorization public key 365 may be derived from the respective private keys and transferred and stored in the wallet on the wallet support service. The device registration public key 375 stored in the wallet allows the user to get access to this wallet by registering one of their devices. The device authorization public key 365 allows the user to initiate an operation on an asset in the wallet. The wallet key pair 380; 385 with which blockchain operations are performed are also stored in the wallet. It can be generated in the wallet on the user device or in the cloud wallet.

The user's credentials 655 are stored in the cloud wallet. This allows the user to always identify themselves (also after renewing identity credentials). In some examples, the need to authenticate can be limited to wallet recovery. Existing banking-standards level security renewable authentication (e.g., using an SSI proof of identity) may be used to authenticate the user vis-à-vis the wallet service application. Authentication vis-à-vis the cloud wallet service, and in particular the wallet service application, may be done inside the secure enclave. For example, the trust anchors may be kept up to date inside the secure enclave for the authentication to work. In other words, the trust anchor or trust anchors may reside inside the secure enclave. Otherwise, the proposed concept may become custodial. However, keeping the trust anchor(s) in the secure enclave up to date may pose a challenge without undesirable frequent software updates. Alternatively, the trust anchor or trust anchors may be fetched from a blockchain. However, there might not be an easy and reliable way to fetch trust anchors from a (public) block chain. For example, the security may depend on a flawless external authentication infrastructure.

After the respective cryptographic keys and pieces of information have been stored in the respective entities, the wallet may be declared as initialized and ready for use. At this point the wallet service may guarantee that the user can always regain access to this wallet.

FIG. 3 further illustrates how operations are performed on a cryptocurrency wallet hosted in a trusted execution environment of the remote server (i.e., the cloud wallet support service). Instructions 354 to perform a wallet operation are signed 356 with the device authorization key 360 (i.e., the first cryptographic secret) and transmitted to the cloud wallet. At the cloud wallet, the device authorization public key 365 is used to verify the signature. The blockchain private key 380 is used to perform the blockchain operation.

In case the crypto wallet/wallet app on the owner's device or crypto wallet app is lost (as the device is stolen, lost, or the app is removed, access to the cryptocurrency wallet can be restored.

While the present disclosure relates to how access to the wallet can be recovered via the wallet service application, access can also be transferred to a new (or secondary) device without requiring authentication vis-à-vis the wallet service application. FIG. 7 illustrates how access to a cryptocurrency wallet hosted in a trusted execution environment of the remote server is transferred to other devices of the wallet owner.

In some cases, the owner can have multiple devices, such as a mobile device 350 and a computer 710, which can also host a crypto wallet app 720. From one of her devices, the wallet owner can request the wallet service to give access to a wallet on another of her devices. The original wallet app can send a signed request to the wallet support service which contains the public key (of the device authorization key pair) of the new wallet app. In this case, the previously used public key of the device authorization key pair is not removed but kept alongside the new public key.

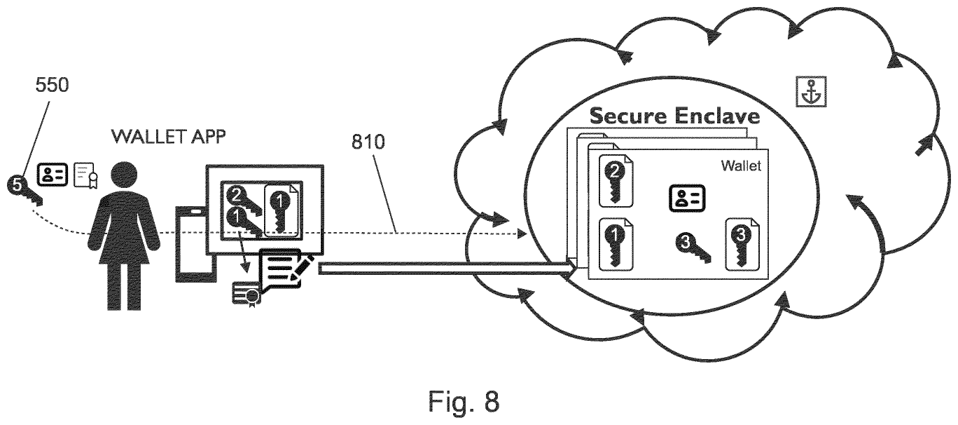

The proposed guarded wallet may also provide more advanced features, such as rate limits and other usage controls. FIG. 8 illustrates how rate limits and other usage controls can be set in a cryptocurrency wallet hosted in a trusted execution environment of the remote server. Rate limits (e.g., daily maximum amount for transactions) and other usage controls may be imposed (by the wallet), configurable by the user. Surpassing the configured restrictions may be allowed after authentication (e.g., via the private key 650 that signs authentication requests). For example, this authentication may be done outside the secure enclave.

For example, a subset of instructions for controlling the cryptocurrency wallet require inclusion of a signed identification certificate of the owner of the cryptocurrency wallet (e.g., the instructions may be signed using the private key 650 that signs the authentication requests). Accordingly, the processing circuitry is configured to authenticate the owner of the cryptocurrency wallet vis-à-vis the wallet service application being executed in the trusted execution environment of the server as secondary security measure for a subset of instructions for controlling the cryptocurrency wallet. For example, the subset of instructions may comprise an instruction for setting a rate limit, an instruction for removing or changing a rate limit, an instruction for setting a usage control, an instruction for removing or changing a usage control, and the control instruction for registering the new first cryptographic secret. The processing circuitry of the wallet control apparatus may be is configured to include the signed identification certificate (e.g., sign the respective instructions with the private key 650 that signs the authentication requests) with the subset of instructions for controlling the cryptocurrency wallet. For example, the wallet service application being configured to execute the subset of instructions upon authentication of the owner of the cryptocurrency wallet. For example, the wallet service application may be configured to verify the subset of instructions based on the information on the signed identification certificate, based on the information on the identity of the owner of the cryptocurrency wallet (and based on the public key of the trust anchor).

Alternatively, multi-signature schemes could be used to protect large operations. In this case the wallet in the enclave would only proceed with a transaction if the request to perform the transaction is signed by multiple parties. A party can be another person, or another device of the wallet owner.

With respect to wallet removal, it may be a choice (or user option) that the wallet can never be removed without first being emptied (assets transferred to another wallet).

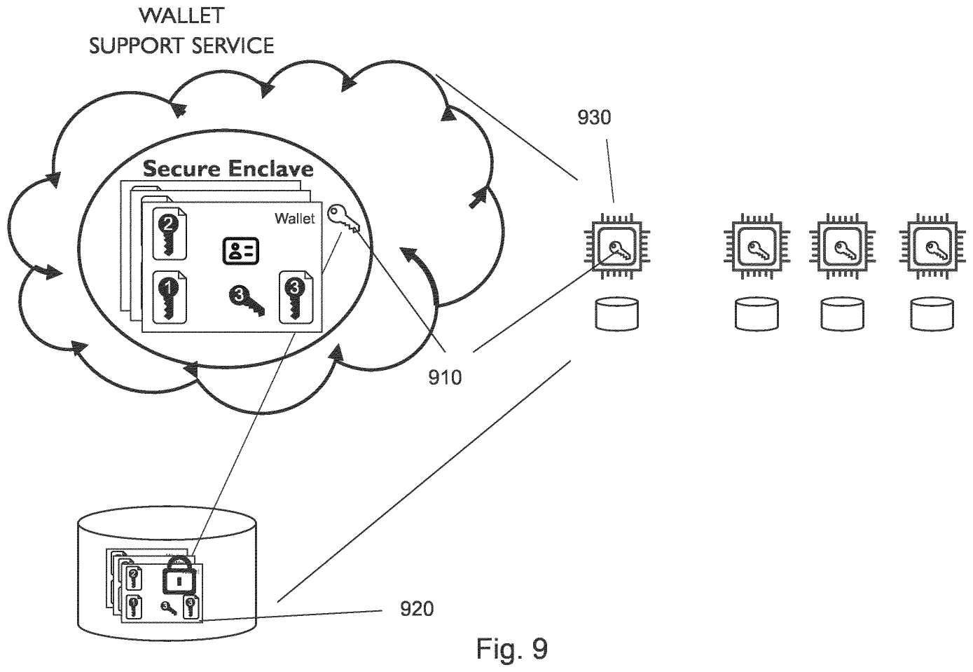

In the following, some details are given on techniques for protecting the wallet(s) stored in the secure enclave(s) of the remote server. FIG. 9 illustrates how a cryptocurrency wallet hosted in a trusted execution environment of a remote server can be protected via persistent storage and redundancy. For the deployment of a cloud wallet service, security and back-up are crucial. For this, a “banking standards security level” may be applied.

For example, the wallet assets may be encrypted and backed up to permanent storage. FIG. 9 shows how encrypted copies 920 of wallet assets are persisted in permanent storage (e.g., the storage circuitry 216 of the remote server). Only the enclave(s) can decrypt (with a global wallet encryption key 910). The wallet support service may be provided by secure hardware 930 (e.g., the processing circuitry 214 of the remote server) with embedded encryption keys 90 that support secure enclave technology (like Intel SGX). Redundancy may be created by replicating both the hardware (with keys) and the persistent storage with the wallet assets.

The proposed concept may support emergency measures for the (highly unlikely) case when all CPU (Central Processing Unit) hardware that contain the global wallet encryption key has become unavailable or broken. In this emergency situation all data on backups become inaccessible.

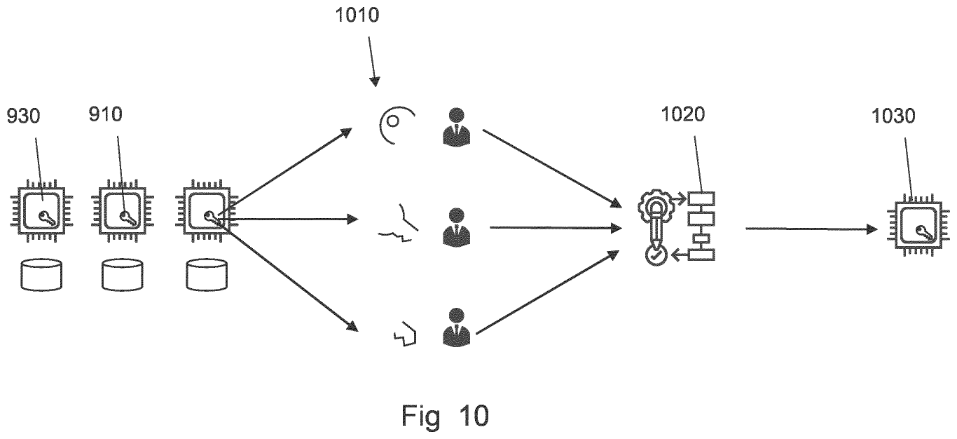

FIG. 10 illustrates emergency measures that can be taken for recovering a cryptocurrency wallet hosted in a trusted execution environment of the remote server. For example, the global encryption key 910 (giving access to all wallets) may be split into different parts 1010 (with e.g., Shamir secret sharing), which are handed over to different key people in the cloud service organization. Very strict procedures may control the situation in which these key parts can be combined 1020 in order to instantiate new enclaves 1030 with the reconstructed key. This reconstructed enclave can now again render the data on the backups accessible again and instantiate other enclaves and populate them with the global encryption key.

The proposed guarded wallet concept may provide easy setup, resistance to human mistakes (and loss of assets), possibility to set usage controls (daily limits, confirmation for large transactions), a decentralized setup, decreased security risks (with respect to sensitivity to vulnerabilities, large scale attacks), and support for different types of assets, at the expense of anonymity.

In general, the proposed concept may be complex to deploy, in particular with respect to software updates to the secure enclaves. This may be ensured by configuring the secure enclaves (i.e., the software running in the secure enclaves) such, that the enclave accepts a software update when it is signed by the auditing party. While this may strengthen the security of the proposed concept, it may also delay procedures in case a quick patch (e.g., of a vulnerability) is required.

To avoid failure in identity certificates (e.g., when a (government) agency makes a mistake and hands out identity certificates to the wrong people), a combination of authentication methods may be used (possibly depending on the amount of value stored in the wallet). To avoid enclaves getting broken and keys being lost, banking security level procedures may be used to prevent this to happen. To avoid that vulnerabilities get introduced in code running in the enclave, the enclaves may be operated at a minimal size, and the enclave code may be checked by a very intensive security review.

More details and aspects of the guard wallet concept are mentioned in connection with the proposed concept, or one or more examples described above or below (e.g., FIG. 1a to 2b). The guard wallet concept may comprise one or more additional optional features corresponding to one or more aspects of the proposed concept, or one or more examples described above or below.

In the following, some examples are presented:
(1) A wallet control apparatus 110 comprising processing circuitry 114 configured to:
   register a new first cryptographic secret at a cryptocurrency wallet hosted in a trusted execution environment 220 on a remote server 200, by:
   generating the first cryptographic secret,
   authenticating an owner of the cryptocurrency wallet vis-à-vis a wallet service application being executed in the trusted execution environment of the server, and
   providing a control instruction for registering the first cryptographic secret at the cryptocurrency wallet to the wallet service application being executed in the trusted execution environment of the server based on the authentication; and
   provide instructions for controlling the cryptocurrency wallet to the remote server, the instructions being cryptographically protected based on the first cryptographic secret.
(2) The wallet control apparatus according to (1), wherein the processing circuitry is configured to register the new first cryptographic secret after loss of a previously used first cryptographic secret.
(3) The wallet control apparatus according to one of (1) or (2), wherein the processing circuitry is configured to authenticate the owner of the cryptocurrency wallet using a signed identification certificate being signed by an independent entity.
(4) The wallet control apparatus according to (3), wherein the processing circuitry is configured to authenticate the owner of the cryptocurrency by signing the control instruction using a private key corresponding to the identification certificate.
(5) The wallet control apparatus according to one of (3) or (4), wherein the processing circuitry is configured to obtain the signed identification certificate from the independent entity.
(6) The wallet control apparatus according to one of (3) to (5), wherein the processing circuitry is configured to authenticate the owner of the cryptocurrency wallet vis-à-vis the wallet service application being executed in the trusted execution environment of the server as secondary security measure for a subset of instructions for controlling the cryptocurrency wallet.
(7) The wallet control apparatus according to one of (1) to (6), wherein the first cryptographic secret is a private key of a device authorization key pair, with the processing circuitry being configured to derive a public key of the device authorization key pair from the private key of the device authorization key pair, and to include the public key of the device authorization key pair in the control instruction for registering the first cryptographic secret.
(8) The wallet control apparatus according to one of (1) to (7), wherein the control instruction for registering the first cryptographic secret at the cryptocurrency wallet comprises a first instruction for removing a previously used first cryptographic secret from the cryptocurrency wallet and a second instruction for registering the new first cryptographic secret at the cryptocurrency wallet.
(9) The wallet control apparatus according to one of (1) to (8), wherein the processing circuitry is further configured to register a new second cryptographic secret at the cryptocurrency wallet, by generating the second cryptographic secret, and providing a control instruction for registering the second cryptographic secret at the cryptocurrency wallet to the wallet service application being executed in the trusted execution environment of the server based on the authentication.
(10) The wallet control apparatus according to (9), wherein the processing circuitry is configured to provide a joint control instruction for registering the first and second cryptographic secret at the wallet.
(11) The wallet control apparatus according to (9), wherein the processing circuitry is configured to provide separate control instructions for registering the first and second cryptographic secret at the wallet.
(12) The wallet control apparatus according to one of (9) to (11), wherein the second cryptographic secret is a private key of a device registration key pair, with the processing circuitry being configured to derive a public key of the device registration key pair from the private key of the device registration key pair, and to include the public key of the device registration key pair in the control instruction for registering the second cryptographic secret.
(13) The wallet control apparatus according to one of (9) to (12), wherein the second cryptographic secret is a cryptographic secret for registering a new first cryptographic secret at the cryptocurrency wallet without requiring additional authentication of the owner of the cryptocurrency wallet vis-à-vis the wallet service application.
(14) A wallet service apparatus 210 comprising processing circuitry 214 configured to:
   provide a trusted execution environment 220;
   host a cryptocurrency wallet inside the trusted execution environment; and
   host a wallet service application 230 inside the trusted execution environment configured to:
   authenticate an owner of the cryptocurrency wallet vis-à-vis the wallet service application,
   obtain a control instruction for registering a new first cryptographic secret at the cryptocurrency wallet from a wallet control apparatus,
   register the new first cryptographic secret at the cryptocurrency wallet, and execute instructions for controlling the cryptocurrency wallet that are cryptographically protected based on the first cryptographic secret.
(15) The wallet service apparatus according to (14), wherein the wallet service application is configured to authenticate the owner of the cryptocurrency wallet based on a signed identification certificate being signed by an independent entity.
(16) The wallet service apparatus according to (15), wherein the trusted execution environment comprises a public key of a trust anchor associated with the independent entity and information on an identity of the owner of the cryptocurrency wallet, wherein the wallet service application is configured to authenticate the owner of the cryptocurrency wallet by verifying a cryptographic signature using the public key of the trust anchor and by comparing the identification information included in the signed identification certificate with the identity of the owner of the cryptocurrency wallet.
(17) The wallet service apparatus according to (16), wherein the verification of the cryptographic signature is based on a certificate chain, with the trust anchor being the root certificate of the certificate chain.
(18) The wallet service apparatus according to one of (14) to (17), wherein the control instruction for registering the first cryptographic secret at the cryptocurrency wallet comprises a first instruction for removing a previously used first cryptographic secret from the cryptocurrency wallet and a second instruction for registering the new first cryptographic secret at the cryptocurrency wallet, the wallet service application being configured to being configured to remove the previously used first cryptographic secret in addition to registering the new first cryptographic secret.
(19) The wallet service apparatus according to one of (14) to (18), wherein a subset of instructions for controlling the cryptocurrency wallet require authenticating the owner of the cryptocurrency wallet as secondary security measure, the wallet service application being configured to execute the subset of instructions upon authentication of the owner of the cryptocurrency wallet.
(20) The wallet service apparatus according to one of (14) to (19), wherein the first cryptographic secret is a private key of a device authorization key pair, the control instruction for registering the first cryptographic secret comprising the public key of the device authorization key pair, the wallet service application being configured to store the public key of the device authorization key pair in the cryptocurrency wallet in the trusted execution environment.
(21) The wallet service apparatus according to one of (14) to (20), wherein the wallet service application is configured to obtain a control instruction for registering a new second cryptographic secret at the cryptocurrency wallet from the wallet control apparatus, to register the second cryptographic secret at the cryptocurrency wallet, and to verify subsequent control instructions for registering a new first cryptographic secret based on the second cryptographic secret.
(22) The wallet service apparatus according to (22), wherein the second cryptographic secret is a private key of a device registration key pair, the control instruction for registering the second cryptographic secret comprising the public key of the device registration key pair, the wallet service application being configured to store the public key of the device registration key pair in the cryptocurrency wallet in the trusted execution environment.
(23) The wallet service apparatus according to (22), wherein the wallet service application is configured to store a third cryptographic secret for signing transactions on a cryptocurrency blockchain in the cryptocurrency wallet in the trusted execution environment, and to sign the transactions on the cryptocurrency blockchain using the third cryptographic secret.
(24) The wallet service apparatus according to one of (14) to (23), wherein a software code of the wallet service application being executed in the trusted execution environment is audited by a third party.
(25) A system comprising the wallet control apparatus according to one of (1) to (13) and the wallet service apparatus according to one of (14) to (24).
(26) A mobile device comprising the wallet control apparatus according to one of (1) to (13).
(27) A server comprising the wallet service apparatus according to one of (14) to (24).
(28) A wallet control method comprising:
   registering 10 a new first cryptographic secret at a cryptocurrency wallet hosted in a trusted execution environment on a remote server, by:
   generating 12 the first cryptographic secret,
   authenticating 14 an owner of the cryptocurrency wallet vis-à-vis a wallet service application being executed in the trusted execution environment of the server, and providing 16 a control instruction for registering the first cryptographic secret at the cryptocurrency wallet to the wallet service application being executed in the trusted execution environment of the server based on the authentication; and
   providing 18 instructions for controlling the cryptocurrency wallet to the remote server, the instructions being cryptographically protected based on the first cryptographic secret.
(29) A wallet service method:
   providing 20 a trusted execution environment;
   hosting 22 a cryptocurrency wallet inside the trusted execution environment; and
   hosting 24 a wallet service application inside the trusted execution environment, the wallet service application performing:
   authenticating 24a an owner of the cryptocurrency wallet vis-à-vis the wallet service application,
   obtaining 24b a control instruction for registering a new first cryptographic secret at the cryptocurrency wallet from a wallet control apparatus,
   registering 24c the new first cryptographic secret at the cryptocurrency wallet, and
   executing 24d instructions for controlling the cryptocurrency wallet that are cryptographically protected based on the first cryptographic secret.
(30) A computer program having a program code for performing the method of (28), when the computer program is executed on a computer, a processor, or a programmable hardware component.
(31) A computer program having a program code for performing the method of (29), when the computer program is executed on a computer, a processor, or a programmable hardware component.

The aspects and features described in relation to a particular one of the previous examples may also be combined with one or more of the further examples to replace an identical or similar feature of that further example or to additionally introduce the features into the further example.

Examples may further be or relate to a (computer) program including a program code to execute one or more of the above methods when the program is executed on a computer, processor, or other programmable hardware component. Thus, steps, operations, or processes of different ones of the methods described above may also be executed by programmed computers, processors, or other programmable hardware components. Examples may also cover program storage devices, such as digital data storage media, which are machine-, processor- or computer-readable and encode and/or contain machine-executable, processor-executable or computer-executable programs and instructions. Program storage devices may include or be digital storage devices, magnetic storage media such as magnetic disks and magnetic tapes, hard disk drives, or optically readable digital data storage media, for example. Other examples may also include computers, processors, control units, (field) programmable logic arrays ((F)PLAs), (field) programmable gate arrays ((F) PGAs), graphics processor units (GPU), application-specific integrated circuits (ASICs), integrated circuits (ICs) or system-on-a-chip (SoCs) systems programmed to execute the steps of the methods described above.

It is further understood that the disclosure of several steps, processes, operations, or functions disclosed in the description or claims shall not be construed to imply that these operations are necessarily dependent on the order described, unless explicitly stated in the individual case or necessary for technical reasons. Therefore, the previous description does not limit the execution of several steps or functions to a certain order. Furthermore, in further examples, a single step, function, process, or operation may include and/or be broken up into several sub-steps, -functions, -processes or -operations.

If some aspects have been described in relation to a device or system, these aspects should also be understood as a description of the corresponding method. For example, a block, device or functional aspect of the device or system may correspond to a feature, such as a method step, of the corresponding method. Accordingly, aspects described in relation to a method shall also be understood as a description of a corresponding block, a corresponding element, a property or a functional feature of a corresponding device or a corresponding system.

The following claims are hereby incorporated in the detailed description, wherein each claim may stand on its own as a separate example. It should also be noted that although in the claims a dependent claim refers to a particular combination with one or more other claims, other examples may also include a combination of the dependent claim with the subject matter of any other dependent or independent claim. Such combinations are hereby explicitly proposed, unless it is stated in the individual case that a particular combination is not intended. Furthermore, features of a claim should also be included for any other independent claim, even if that claim is not directly defined as dependent on that other independent claim.

What is claimed is:

1. A wallet control apparatus comprising processing circuitry configured to:
register a new first cryptographic secret at a cryptocurrency wallet hosted in a trusted execution environment on a remote server, by:
generating the first cryptographic secret,
authenticating an owner of the cryptocurrency wallet vis-à-vis a wallet service application being executed in the trusted execution environment of the server, and
providing a control instruction for registering the first cryptographic secret at the cryptocurrency wallet to the wallet service application being executed in the trusted execution environment of the server based on the authentication; and
provide instructions for controlling the cryptocurrency wallet to the remote server, the instructions being cryptographically protected based on the first cryptographic secret.

2. The wallet control apparatus according to claim 1, wherein the processing circuitry is configured to register the new first cryptographic secret after loss of a previously used first cryptographic secret.

3. The wallet control apparatus according to claim 1, wherein the processing circuitry is configured to authenticate the owner of the cryptocurrency wallet using a signed identification certificate being signed by an independent entity.

4. The wallet control apparatus according to claim 3, wherein the processing circuitry is configured to authenticate the owner of the cryptocurrency by signing the control instruction using a private key corresponding to the identification certificate.

5. The wallet control apparatus according to claim 3, wherein the processing circuitry is configured to obtain the signed identification certificate from the independent entity.

6. The wallet control apparatus according to claim 3, wherein the processing circuitry is configured to authenticate the owner of the cryptocurrency wallet vis-à-vis the wallet service application being executed in the trusted execution environment of the server as secondary security measure for a subset of instructions for controlling the cryptocurrency wallet.

7. The wallet control apparatus according to claim 1, wherein the first cryptographic secret is a private key of a device authorization key pair, with the processing circuitry being configured to derive a public key of the device authorization key pair from the private key of the device authorization key pair, and to include the public key of the device authorization key pair in the control instruction for registering the first cryptographic secret.

8. The wallet control apparatus according to claim 1, wherein the control instruction for registering the first cryptographic secret at the cryptocurrency wallet comprises a first instruction for removing a previously used first cryptographic secret from the cryptocurrency wallet and a second instruction for registering the new first cryptographic secret at the cryptocurrency wallet.

9. The wallet control apparatus according to claim 1, wherein the processing circuitry is further configured to register a new second cryptographic secret at the cryptocurrency wallet, by generating the second cryptographic secret, and providing a control instruction for registering the second cryptographic secret at the cryptocurrency wallet to the wallet service application being executed in the trusted execution environment of the server based on the authentication.

10. The wallet control apparatus according to claim 9, wherein the processing circuitry is configured to provide a joint control instruction for registering the first and second cryptographic secret at the wallet.

11. The wallet control apparatus according to claim 9, wherein the processing circuitry is configured to provide separate control instructions for registering the first and second cryptographic secret at the wallet.

12. The wallet control apparatus according to claim 9, wherein the second cryptographic secret is a private key of a device registration key pair, with the processing circuitry being configured to derive a public key of the device registration key pair from the private key of the device registration key pair, and to include the public key of the device registration key pair in the control instruction for registering the second cryptographic secret.

13. The wallet control apparatus according to claim 9, wherein the second cryptographic secret is a cryptographic secret for registering a new first cryptographic secret at the cryptocurrency wallet without requiring additional authentication of the owner of the cryptocurrency wallet vis-à-vis the wallet service application.

14. A wallet service apparatus comprising processing circuitry configured to:
provide a trusted execution environment;
host a cryptocurrency wallet inside the trusted execution environment; and
host a wallet service application inside the trusted execution environment configured to:
authenticate an owner of the cryptocurrency wallet vis-à-vis the wallet service application,
obtain a control instruction for registering a new first cryptographic secret at the cryptocurrency wallet from a wallet control apparatus,
register the new first cryptographic secret at the cryptocurrency wallet, and
execute instructions for controlling the cryptocurrency wallet that are cryptographically protected based on the first cryptographic secret.

15. The wallet service apparatus according to claim 14, wherein the wallet service application is configured to authenticate the owner of the cryptocurrency wallet based on a signed identification certificate being signed by an independent entity.

16. The wallet service apparatus according to claim 15, wherein the trusted execution environment comprises a public key of a trust anchor associated with the independent entity and information on an identity of the owner of the cryptocurrency wallet, wherein the wallet service application is configured to authenticate the owner of the cryptocurrency wallet by verifying a cryptographic signature using the public key of the trust anchor and by comparing the identification information included in the signed identification certificate with the identity of the owner of the cryptocurrency wallet.

17. The wallet service apparatus according to claim 16, wherein the verification of the cryptographic signature is based on a certificate chain, with the trust anchor being the root certificate of the certificate chain.

18. A wallet control method comprising:
registering a new first cryptographic secret at a cryptocurrency wallet hosted in a trusted execution environment on a remote server, by:
generating the first cryptographic secret,
authenticating an owner of the cryptocurrency wallet vis-à-vis a wallet service application being executed in the trusted execution environment of the server, and
providing a control instruction for registering the first cryptographic secret at the cryptocurrency wallet to the wallet service application being executed in the trusted execution environment of the server based on the authentication; and
providing instructions for controlling the cryptocurrency wallet to the remote server, the instructions being cryptographically protected based on the first cryptographic secret.

19. A computer program having a program code for performing the method of claim 18, when the computer program is executed on a computer, a processor, or a programmable hardware component.

20. A wallet service method:
providing a trusted execution environment;
hosting a cryptocurrency wallet inside the trusted execution environment; and
hosting a wallet service application inside the trusted execution environment, the wallet service application performing:
authenticating an owner of the cryptocurrency wallet vis-à-vis the wallet service application,
obtaining a control instruction for registering a new first cryptographic secret at the cryptocurrency wallet from a wallet control apparatus,
registering the new first cryptographic secret at the cryptocurrency wallet, and
executing instructions for controlling the cryptocurrency wallet that are cryptographically protected based on the first cryptographic secret.
